(19) United States
(12) Patent Application Publication
(10) Pub. No.: US 2025/0165768 A1
(43) Pub. Date: May 22, 2025

(54) EDGE-CLIENT COLLABORATIVE FEDERATED GRAPH LEARNING WITH ADAPTIVE NEIGHBOR GENERATION

(71) Applicant: FUZHOU UNIVERSITY, Fuzhou (CN)

(72) Inventors: Zheyi CHEN, Fuzhou (CN); Luying ZHONG, Fuzhou (CN); Yifan HUANG, Fuzhou (CN); Longxiang XUE, Fuzhou (CN)

(73) Assignee: FUZHOU UNIVERSITY, Fuzhou (CN)

(21) Appl. No.: 18/399,696

(22) Filed: Dec. 29, 2023

Related U.S. Application Data
(63) Continuation of application No. PCT/CN2023/132495, filed on Nov. 20, 2023.

(51) Int. Cl. G06N 3/08; G06N 3/0455

(52) U.S. Cl. CPC G06N 3/08; G06N 3/0455

(57) ABSTRACT

An Edge-Client Collaborative Federated Graph Learning with Adaptive Neighbor Generation is provided. To promote the information flow in edge-client collaboration and extract more generalized potential relationships between clients. In SpreadFGL, an adaptive graph imputation generator incorporated with a versatile assessor is first designed to exploit the potential links between subgraphs, without sharing raw data. Next, a new negative sampling mechanism is developed to make SpreadFGL concentrate on more refined information in downstream tasks. To facilitate load balancing at the edge layer, SpreadFGL follows a distributed training manner that enables fast model convergence. Using real-world testbed and benchmark graph datasets, extensive experiments demonstrate the effectiveness of the proposed SpreadFGL.

### CROSS REFERENCE TO THE RELATED APPLICATIONS

This application is the continuation application of International Application No. PCT/CN2023/132495, filed on Nov. 20, 2023, the entire contents of which are incorporated herein by reference.

### TECHNICAL FIELD

The present invention belongs to the technical field of Federated Graph Learning, in particular relates to edge-client collaborative federated graph learning with adaptive neighbor generation.

### BACKGROUND

With powerful expressive capabilities, graphs have been widely used to depict real-world application scenarios such as social network, knowledge graph. In the area of graph learning, the emerging Graph Neural Networks (GNNs) have gained significant attention due to their exceptional performance in dealing with graphrelated tasks. GNNs efficiently utilize the feature propagation by employing multiple graph convolutional layers for node classification tasks, where the structural knowledge is distilled into discriminative representations from complex graph-orient data in diverse domains such as prediction modeling, malware detection, and resource allocation. Commonly, the training performance of GNNs depends on the substantial graph data distributed among clients. However, due to privacy and overhead concerns, it is impractical to assemble graph data from all clients for GNN training.

Following a distributed training mode, Federated Graph Learning (FGL) aims to deal with the problem of graph data island by promoting cooperative training among multiple clients. To protect privacy, the FGL offers generalized graph mining models over distributed subgraphs without sharing raw data. Many studies have verified the feasibility of FGL in various domains such as transportation, computer vision, and edge intelligence. Recently, some studies also adopted FGL-based frameworks for semi-supervised classification tasks. These approaches typically join an edge server with multiple clients to train a globally-shared classifier for downstream tasks, where the clients and edge server undertake local updating and global aggregation, respectively.

In real-world FGL application scenarios, there are potential links between the subgraphs of a client and others since these subgraphs contain significant information about neighbor clients. However, previous FGL-related studies overlooked such important links among clients, as shown in FIG. 1 (left). This oversight results in the insufficient feature propagation of multi-hop neighbors during local model training, ultimately leading to degraded performance in classification tasks. To explore the potential links among clients, some prior studies inferred the missing links in subgraphs, as shown in FIG. 1 (middle). For example, Zhang et al. employed linear predictors on local models to conduct the missing links in subgraphs. However, the potential links rely solely on local clients, disregarding meaningful information from neighbor clients. Therefore, the features implied in the generated links may be incomplete and infeasible to recover the cross-client information. Moreover, most existing studies commonly adopted the classic FedAvg algorithm, neglecting the high training costs when the number of clients continues to expand, which leads to a serious singlepoint overload problem.

### SUMMARY

The purpose of the present invention is to provide a edge-Client Collaborative Federated Graph Learning with Adaptive Neighbor Generation, consider the typical FGL scenario with distributed graph datasets; based on this setting, first propose an improved centralized FGL framework, named FedGL; next, extend the FedGL to the scenario of multi-edge collaboration and propose a novel distributed FGL framework, named SpreadFGL.

Consider an edge server to communicate with M clients; the FedGL leverages the edge server Sⱼ as an intermediary to facilitate the information flow among clients, where Sⱼ covers all clients, denoted by Mⱼ=M; incorporate a graph imputation generator to construct learnable links, thereby generating the latent links between subgraphs; employ a L-layer GNN model with the local node classifier Fᵢ^{j}, defined as

$${H}^{( j , i )} = {GNNconv}_{w ( j , i )} ( {ε}^{ji} , {X}^{ji} ) \qquad ( 6 )$$

where GNNconv(⋅) is a GNN model and H^{(j,i)} indicates the GNN output of the l-th client covered by Sⱼ; the feature propagation of the (l+1)-th layer is given in Eq. (3); moreover, the Cross-Entropy loss function is adopted for the l-th client covered by Sⱼ in the downstream tasks, defined as

$${ℒ}_{{F}_{i}^{j}} = {i}_{j}^{} ( {F}_{i}^{j} ( {W}_{( j , i )} ) ) = - {\sum }_{u = 1}^{\vert {t}_{ji}^{} \vert} {\sum }_{r = 1}^{c} {Y}_{ur}^{ji} ln {H}^{( j , i )} \qquad ( 7 )$$

where Yᵤ^{ji} is the inference vector of the node u conducted by local training;

For every edge-client communication in FedGL, each client parallelly trains the local node classifier Fᵢ^{j} parameterized by W_{(j,i)} in local training rounds, formulated as

$${W}_{( j , t )}^{t + 1} = {W}_{( j , t )}^{t} - α ∇ {R}_{i} ( {F}_{i} ( {W}_{( j , t )}^{t} ) ) \qquad ( 8 )$$

where α is the learning rate; t∈[Tₗ−1] indicates the local training rounds;

After local training, Sⱼ aggregates local parameters {W_{(j,i)}|i∈[Mⱼ]} to update global ones Wⱼ, and then broadcasts Wⱼ to all clients at each edge-client communication.

The clients upload the processed embeddings {H^{(j,i)}|i∈[Mⱼ]} to the edge server at every [symbol] intervals of edge-client communication, where the original linked nodes remain proximate in the low-dimensional space; next, the graph imputation generator performs the fusion on the processed embeddings to obtain the globally-shared information H^{j}∈ [symbol] | [symbol] ^{j}|×c, where v^{j} is the number of all clients covered by Sⱼ; based on this, H^{j} is denoted as

$${H}^{j} = ⌊ {H}^{( j , 1 )} ‖ … ‖ {H}^{( j , {M}_{j} )} ⌋ . \qquad ( 9 )$$

The graph imputation generator utilizes the distance to evaluate the node similarity and construct the global topology graph, referred to Ā^{j}=H^{j}H^{j}^{^{T}}; next, k most similar nodes are selected from this topology graph as potential cross-subgraph links, denoted by the set ε̅^{j}; to generate the potential feature vectors X̅^{j} under the guidance of the globally-shared information, an autoencoder parameterized by ΦAE is used to explore overcomplete underlying representations from H^{j}; furthermore, to guarantee data privacy, the random noisy vector S is input to the autoencoder, and thus the output of the autoencoder is reconstructed as H̅^{j}=h(f(S)), where f(⋅) and h(⋅) are the encoder and decoder, respectively; it is noted that X̅^{j}=f(S) indicates the potential features expected to be extracted by the encoder; with the autoencoder, the random noisy vector is mapped to the same dimension as H^{j}, and the output of the (l+1)-th layer is defined as

$${\overline{H}}^{( j , l + 1 )} = σ ( {\overline{H}}^{( j , l )} {W}_{a}^{( j , l + 1 )} + {b}_{a}^{( j , l + 1 )} ) \qquad ( 10 )$$

where Wₐ^{(j,l+1)}∈ [symbol] ^{d}^{ₗ}^{×d}^{ₗ₊₁} and bₐ^{(j,l+1)}∈ [symbol] ^{d}^{ₗ} are the layer-specific weights and biases, respectively; σ(⋅) denotes the activation function.

The assessor adopts a fully-connected neural network to evaluate H̅^{j}; the assessor takes the reconstructed globally shared information H̅^{j} as input in the form of a value, which is positively correlated with the quality evaluation of the reconstructed data; hence, the autoencoder tends to obtain a higher value under the supervision of the assessor and extract more valid global information; specifically, the loss function of the autoencoder is defined as

$$\begin{matrix}{\hat{ℒ}}_{AE} = - {\sum }_{u} {𝔼}_{p ( {\overline{h}}_{u}^{j} \vert ∀ u ∈ {𝒱}^{j} )} ( Assor ( {\overline{h}}_{u}^{j} ) ) , \\ = \frac{1}{\vert {j}^{} \vert} {\sum }_{u} log ( 1 - Assor ( {\overline{h}}_{u}^{j} ) )\end{matrix} , \qquad ( 11 )$$

where [symbol] ₚ(⋅) is the expectation of the variables in p(⋅), and p(hᵤ^{-j}|∀u∈v^{j}) indicates h sampled from the distribution of H̅^{j}; Assor(⋅) is the assessor that evaluates the constructed global information; to distinguish the original and reconstructed global data, we regard the globally-shared information as the criterion and train the assessor to assign higher scores; the assessor is trained to assign lower scores with the reconstructed global information; the assessor is able to guide the autoencoder to evolve more discriminative representations of latent features; the loss function of the assessor is defined as

$$\begin{matrix}{\hat{ℒ}}_{AS} = - {\sum }_{n} [ {𝔼}_{p ( {h}_{u}^{j} \vert ∀ u ∈ {𝒱}^{j} )} ( Assor ( {h}_{u}^{j} ) ) + \\ {𝔼}_{p ( {\overline{h}}_{u}^{j} \vert ∀ u ∈ {𝒱}^{j} )} ( 1 - Assor ( {\overline{h}}_{u}^{j} ) ) ] \\ = \frac{1}{\vert {j}^{} \vert} {\sum }_{u} [ log ( 1 - Assor ( {h}_{u}^{j} ) ) + log ( Assor ( {\overline{h}}_{u}^{j} ) ) ]\end{matrix} \qquad ( 12 )$$

where p(hᵤ^{j}|∀u∈v^{j}) denotes hᵤ^{j} sampled from the distribution of H^{j};

The training processes of the autoencoder and assessor are performed simultaneously, where the assessor guides the autoencoder to learn more discriminative reconstructed data and potential features through back-propagation.

Based on the proposed versatile assessor, we first set a threshold θ∈(0, 1) in every training iteration of the autoencoder and select the attributes in hᵤ^{j} that are less than θ; these attributes are deemed as negative and their feedbacks from the assessor are 0; next, the zero-regularization is used to process these negatives, and thus both the autoencoder and the assessor can spotlight the representations that are meaningful for downstream tasks; hence, the loss function of the assessor is updated and redefined as

$${ℒ}_{AS} = \frac{1}{\vert {j}^{} \vert} {\sum }_{u} [ log ( 1 - Assor ( {h}_{u}^{j} ⊙ {e}_{u} ) ) + log ( Assor ( {\overline{h}}_{u}^{j} ⊙ {e}_{u} ) ) ] , \qquad ( 13 )$$

where eᵤ is a c-dimensional vector that judges whether hᵤᵢ^{j}∈hᵤ^{j} is higher than θ (eᵤᵢ=1) or not (eᵤᵢ=0); ⊙ is the element-wise multiplication; correspondingly, the loss function of the autoencoder is updated and redefined as

$${ℒ}_{AE} = \text{} \frac{1}{\vert {j}^{} \vert} \text{} {\sum }_{u} [ \text{} log ( 1 - Assor ( {\overline{h}}_{u}^{j} ⊙ {e}_{u} ) ) + {‖ {h}_{u}^{j} ⊙ ( - {e}_{u} ) - {\overline{h}}_{u}^{j} ⊙ ( - {e}_{u} ) ‖}_{2}^{2} ] , \qquad ( 14 )$$

where hᵤ^{j} and h̅ᵤ^{j} are the u-th vector of H^{j} and H̅^{j}, respectively; [symbol] is an indicator vector with the values of 1; through the above operations, ε̅^{j} and X̅^{j} are used to form the learnable potential graph [symbol] =( [symbol] ^{j}, ε̅^{j}, X̅^{j}).

The edge server Sⱼ divides [symbol] into some subgraphs, denoted by the set { [symbol] ^{ji}( [symbol] ^{ji}, ε̅^{ji}, [symbol] ^{ji})|i∈[Mⱼ]}, where ε̅^{ji}={ε̅ᵤᵥ^{ji}|ε̅ᵤᵥ^{ji}∈ε̅^{j}, ∀u, u∈v^{ji}} is the neighbor set of v^{ji}, [symbol] ^{ji}={x̅ᵤ^{ji}|u∈v^{ji}}, and x̅ᵤ^{ji}={x̅ᵤ^{ji}|ēᵤᵥ^{ji}∈ε̅^{ji}} indicates the potential neighbor feature vectors of u; next, Sⱼ assigns the subgraphs to each client; it is noted that each local client repairs the subgraph by using the local graphic patcher Pᵢ^{j} referring to [symbol] ^{ji}=Pᵢ^{j}( [symbol] ^{ji}); by collaborating with the edge server, clients are expected to acquire diverse neighbor features from globally-shared information, thereby fixing cross-subgraph missing links.

Propose a novel distributed FGL framework, named SpreadFGL, that extends the FedGL to a multi-edge environment; the SpreadFGL is able to facilitate more efficient FGL training and better load balancing in a multiedge collaborative environment; consider that there are N edge servers, and an edge server Sⱼ is equipped with a global node classifier Fⱼ parameterized by Wⱼ; besides, a client only communicates with its closest edge server; there exist neighbor relationships among the servers, denoted by the matrix A∈ [symbol] ^{N×N}; if Sᵢ and Sⱼ are neighbors, aᵢⱼ=1; otherwise, aᵢⱼ=0; moreover, the parameter transmission is permitted between neighbor servers;

In SpreadFGL, the clients adopt the L-layer GNNs; the edge servers exchange information with the covered clients in each edge-client communication; at each K intervals of edge-client communications, the clients and their nearest edge servers collaboratively utilize the shared information to extract the potential links based on the proposed graph imputation generator and negative sampling mechanism;
design a weight regularizer during the local training; based on trace normalization, the regularizer is used to enhance the network learning capability of the local node classifiers; specifically, the loss function of the i-th client under the coverage of Sⱼ is defined as

$$\begin{matrix}{ℒ}_{{F}_{i}^{j}} = {i}_{j}^{} ( {F}_{i}^{j} ( {W}_{( j , i )} ) ) \\ = - {\sum }_{u = 1}^{\vert {t}_{ji}^{} \vert} {\sum }_{r = 1}^{C} {Y}_{ur}^{ji} ln {H}^{( j , i )} + Tr ( {W}_{( j , i , L )} {W}_{( j , i , L )}^{T} ) ,\end{matrix} \qquad ( 15 )$$

where Tr(⋅) is the square matrix trace; W_{(j,i,L)} indicates the parameters of L-th GNN layer for the local node classifier Fᵢ^{j};

To better explore the potential cross-subgraph links by using the information from other servers, adopt the topology structure at the edge layer to facilitate the parameter transmission between neighbor servers; this enables the information flow among clients via the gradient propagation at each [symbol] intervals of edge-client communication; specifically, Sⱼ first aggregates the model parameters of its neighbor servers; next, Sⱼ averages the parameters and broadcast them to the covered clients; this process can be described as

$${W}_{j} ← 1 / ( {\sum }_{r = 1}^{N} {a}_{rj} {M}_{r} ) {\sum }_{r = 1}^{N} {\sum }_{i = 1}^{{M}_{r}} {a}_{rj} {W}_{( r , i )} \qquad ( 16 )$$

Compared with the prior art, the present invention has the following beneficial effects:
we design the FedGL to repair the missing links between clients, where a new graph imputation generator is developed that incorporates a versatile assessor and negative sampling mechanism to explore refined global information flow, extracting unbiased latent links and thus improving the training effect. through ablation experiments and convergence analysis, we validate the effectiveness of the core components designed in the proposed frameworks and the advantage of the SpreadFGL for achieving faster convergence speed.

### BRIEF DESCRIPTION OF THE DRAWINGS

FIG. 1 shows Comparison between the classic FGL and the FedGL designed in the proposed SpreadFGL. In FIG. 1 (left), the FGL does not consider the inter-links between clients, causing insufficient feature propagation of multihop neighbors. In FIG. 1 (middle), the FGL solely infers the missing links by local subgraphs but ignores the meaningful information in neighbor clients. In FIG. 1 (right), the proposed FedGL utilizes the globally-shared information among clients, thereby extracting important cross-subgraph links for classification tasks;

FIG. 2 shows Overview of the proposed SpreadFGL. The SpreadFGL targets a distributed scenario that consists of multiple edge servers and clients. At the edge layer, the autoencoder is employed to explore potential global features of the covered clients, and then the versatile assessor is combined with a negative sampling mechanism to supervise refined information, where model parameters transmission is permitted between neighbor edge servers. At the client layer, GNNs are used as local node classifiers for downstream tasks, and then graphic patchers are employed to repair subgraphs and missing cross-subgraph links;

FIG. 3 shows real-world testbed for FedGL and SpreadFG;

FIG. 4 shows ACC of SpreadFGL with various numbers of clients and labeled ratios;

FIG. 5 shows Accuracy of SpreadFGL with different values of [symbol] ;

FIG. 6 shows ACC of SpreadFGL with various local training iterations T;

FIG. 7 shows ablation study on negative sampling mechanism and versatile assessor when M=6 and the labeled ratio is 0.3;

FIG. 8 shows training loss of different FGL-based frameworks when M=6 and the labeled ratio is 0.3;

FIG. 9 shows ACC of different FGL-based frameworks when M=6 and the labeled ratio is 0.3.

### DETAILED DESCRIPTION OF THE EMBODIMENTS

The technical solution of the present invention is described in detail in combination with the accompany drawings.

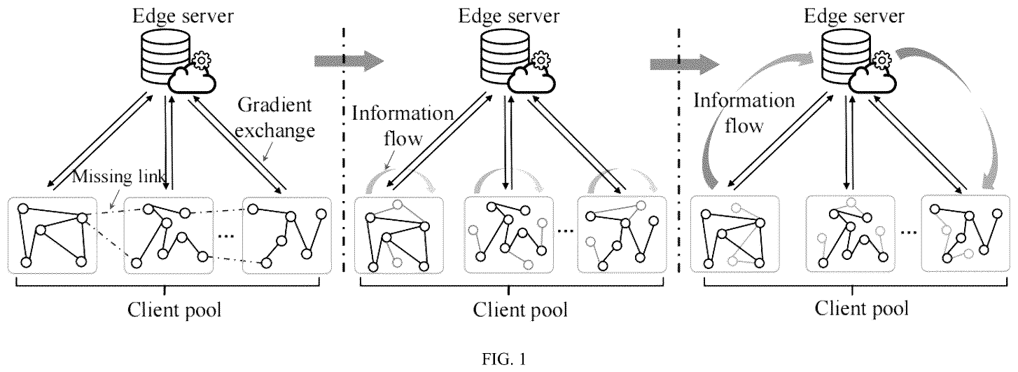

Proposed in the present invention is a Edge-Client Collaborative Federated Graph Learning with Adaptive Neighbor Generation. Framework is as shown in FIG. 1.

The method specifically comprises the following design process:

To address these essential challenges, we propose FedGL, an improved centralized FGL framework, to explore potential cross-subgraph links by leveraging the global information flow. As illustrated in FIG. 1 (right), we consider the edge server as an intermediary to facilitate the flow of global information, thereby enhancing communication among different clients and fostering the collaborative knowledge integration of their subgraphs. Thus, the proposed FedGL is able to extract unbiased and generalized missing links through collaboration among the edge server and clients. Furthermore, we extend the FedGL to a multi-edge collaborative scenario and propose the SpreadFGL to efficiently handle the load balancing issue at the edge layer. The main contributions of this application are summarized as follows.
We propose an improved centralized FGL framework, named FedGL. In FedGL, GNNs are utilized as the node classifiers in clients for semi-supervised classification tasks, ensuring effective feature propagation.
We design an adaptive graph imputation generator to explore generalized potential cross-subgraph links, referring to the globally-shared topology graph at the edge layer.
We develop a new versatile assessor that incorporates a negative sampling mechanism to supervise the process of generating subgraphs, where the discriminate features are constructed by autoencoder. Thus, we can focus on more refined features that are beneficial to classification tasks.
We propose a novel distributed FGL framework, named SpreadFGL, which extends the FedGL to a multi-edge scenario. In SpreadFGL, the neighbor edge servers collaboratively conduct model training with a well-designed distributed loss function, enabling efficient extraction of the potential links between subgraphs. Thus, the SpreadFGL facilitates faster model convergence and better load balancing at the edge layer.
Using real-world testbed and benchmark graph datasets, extensive experiments are conducted to demonstrate the superiority of the proposed SpreadFGL. The results show that the SpreadFGL outperforms state-of-the-art algorithms from the perspectives of model accuracy and convergence speed.

### 1. Related Work

### A. GraphNeuralNetworks

Graph Neural Networks [18] have drawn considerable attention in recent years due to their remarkable capabilities. As an emerging technique in semi-supervised learning, GNNs
can achieve accurate node classification for massive unlabeled nodes by training scarce labeled data. Considering the advanced ability in modeling graph structures, GNNs have derived several variants such as Graph Convolutional Networks (GCNs), Graph Attention Networks (GAT), and GraphSAGE. For example, GCNs conduct the operations of neural networks on graph topology, which have been widely used in semi-supervised learning tasks. The inference vector of the node u on the (l+1)-th GCN layer is defined as

$${h}_{u}^{( l + 1 )} = σ \{ AGG ( {h}_{υ}^{( l )} , {e}_{u υ} ) \vert ∀ υ ∈ \} \qquad ( 1 )$$

where hᵥ^{(l)} is the vector of the node u in the l-th GCN layer. eᵤᵥ indicates the link between the node u and v. AGG(⋅) is an aggregator function used to integrate the neighbor features of node u via eᵤᵥ. And σ(⋅) is a non-linear activation function.

The GAT incorporates GCNs with attention mechanisms to adaptively assign the weights αᵤᵥ^{(l+1)} for the neighbors of the node u, and the inference vector is defined as

$${h}_{u}^{( l + 1 )} = σ \{ AGG ( {α}_{u υ}^{( l + 1 )} , {e}_{u υ} ) \vert ∀ υ ∈ \} \qquad ( 2 )$$

The GraphSAGE aggregates node features by sampling from neighbor nodes and the inference vector is defined as

$${h}_{u}^{( l + 1 )} = σ \{ {h}_{u}^{( l )} ‖ AGG ( {h}_{υ}^{( l )} , {e}_{u υ} ) \vert ∀ υ ∈ \} \qquad ( 3 )$$

where ∥ denotes the concatenation operation.

There is an urgent need to study the restoration of missing cross-subgraph links for better handling the semi-supervised node classification.

### B. Federated Graph Learning

Federated Graph Learning (FGL) has emerged as a captivating topic in recent years. Different from the classic GNN that relies on centralized feature propagation across the entire graph, FGL enables distributed clients to collectively maintain a globally-shared model through gradient aggregation. Many efforts have contributed to this topic. For instance, He et al. proposed a graph-level scheme that distributed graph datasets across multiple clients, catering to various downstream tasks. Wu et al. designed an FGL framework for recommendation tasks, where subgraphs contain overlapped items. Xie et al. developed an FGL based framework to mitigate the heterogeneity among features and graphs. They employed clustering techniques to aggregate clients based on the GNN gradients, aiming to enhance the collaboration efficiency of federated learning.

However, the above studies overlooked the pervasive missing links between clients happened in real-world scenarios, which may cause undesired performance in downstream tasks.

To the best of our knowledge, few studies well considered and tackled the problem of missing cross-subgraph links. Zhang et al. utilized a local linear predictor to explore the potential relationships between clients according to the local subgraph structure. However, the cross-subgraph relationships rely on important information from neighbor clients, which makes it hard to find the potential links only using local subgraphs, thereby leading to inefficient recovery of crossclient information. Moreover, prior studies commonly adopted the classic FedAvg for training, ignoring the overload of a single node (e.g., edge server) especially when the number of clients expands.

### 2. The Proposed SpreadFGL

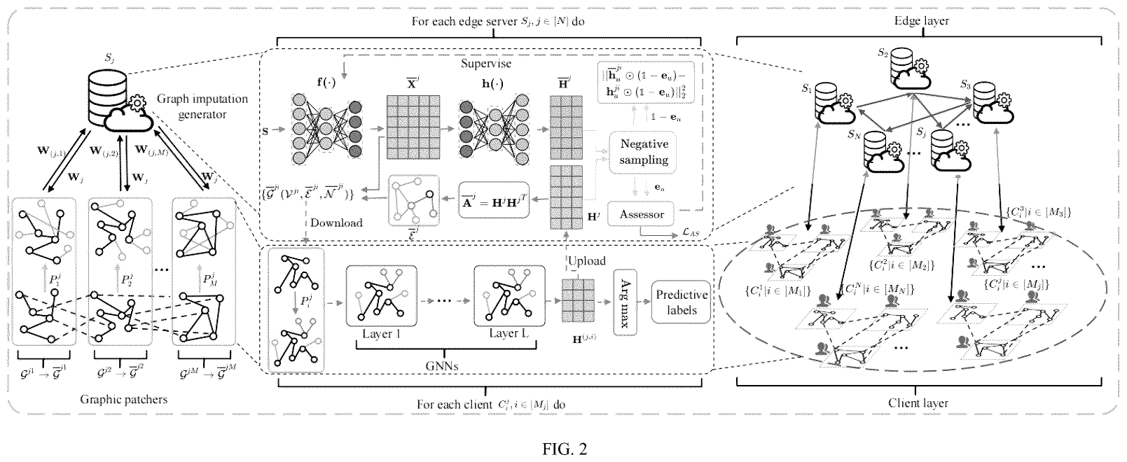

In this section, we consider the typical FGL scenario with distributed graph datasets. Based on this setting, we first propose an improved centralized FGL framework, named FedGL. Next, we extend the FedGL to the scenario of multi-edge collaboration and propose a novel distributed FGL framework, named SpreadFGL. Specifically, FIG. 2 provides a detailed illustration of the proposed SpreadFGL.

### A. Overview and Motivation

A graph dataset is denoted as [symbol] ( [symbol] , Y)_{D(G,Y)}, where [symbol] =( [symbol] , ε, X) is a global graph. [symbol] is the node set, where | [symbol] |=n, ε={eᵤᵥ} is the edge set that stores the link relationship between the nodes [symbol] and [symbol] , where ∀ [symbol] , v∈ [symbol] . X∈ [symbol] ^{n×d} indicates the node feature matrix, where [symbol] ∈ [symbol] ^{d} is the feature vector of the i-th node. Y=[0, 1]∈ [symbol] ^{n×c} is the label matrix, where c is the number of classes. Considering that there are N edge servers and M clients. The edge server Sⱼ covers Mⱼ local clients {Cᵢ^{j}| [symbol] ∈[Mⱼ]} to conduct the FGL training, where Σⱼ₌₁^{N}Mⱼ=M. The client [symbol] owns the part samples of the graph dataset, denoted by [symbol] ᵢ^{j}{ [symbol] ^{ji}, Y^{ji}}, where [symbol] ^{ji}=( [symbol] ^{ji}, ε^{ji}, X^{ji}) is a local subgraph and Y^{ji} is the sub-label matrix of nodes v^{ji}. To simulate the realworld scenario of missing links between clients, we consider that there are no shared nodes and connected links among clients, formulated by [symbol] ^{ji}∩ [symbol] ^{ĵr}=∅, where ∀ [symbol] , r∈[Mⱼ] and [symbol] ≠r if [symbol] = [symbol] , and [symbol] ∈[Mⱼ], ∀r∈[M_{ĵ}] if [symbol] ≠ĵ. The subgraphs of all clients form the complete graph, defined by Σⱼ₌₁^{N}Σᵢ₌₁^{M}^{ⱼ}| [symbol] ^{ji}|=n. Thus, there is no link between any two clients, and a client cannot directly retrieve the node features from another client. For clarity, Table I lists the main notations used in this application.

Based on the above scenario, the client [symbol] , owns a local node classifier Fᵢ^{j}, and graphic patcher Pᵢ^{j}, and all clients can jointly learn graph representations for semi-supervised node classification. Generally, the proposed SpreadFGL aims to conduct collaborative learning on independent subgraphs across all clients, prioritizing the privacy of raw data. Therefore, the SpreadFGL obtains the global node classifiers {Fⱼ|j∈[N]} parameterized by {Wⱼ|j∈[N]} in the edge servers for downstream tasks. With this consideration, we formulate the optimization problem as minimizing the aggregated risks to find the optimal weights {Wⱼ|j∈[N]}, defined as

$${\sum }_{j = 1}^{N} {min}_{{W}_{j}} {ℛ}_{j} ( {F}_{j} ( {W}_{j} ) ) = {\sum }_{j = 1}^{N} {min}_{{W}_{( j , i )}} \frac{1}{{M}_{j}} {\sum }_{i = 1}^{{M}_{i}} {ℛ}_{i}^{j} ( {F}_{i}^{j} ( {W}_{( j , i )} ) ) \qquad ( 4 )$$

where W_{(j,i)} is the learnable weights of local node classifier Fᵢ^{j}. [symbol] ᵢ^{j} is the loss function of the global node classifier Fⱼ. And [symbol] ᵢ^{j} i is the loss function of the i-th client that is used to measure the local empirical risk,

$${ℛ}_{i}^{j} ( {F}_{i}^{j} ( {W}_{( j , i )} ) ) = \frac{1}{\vert {t}_{ji}^{} \vert} {\sum }_{υ ∈ {t}_{ji}^{}} {ℛ}_{i}^{j} ( {W}_{j} ; {F}_{i}^{j} ( {ji}^{} ( υ ) ) , {y}_{υ}^{ji} ) \qquad ( 5 )$$

Where [symbol] ₜ^{ji}⊆ [symbol] ^{ji} is the labeled training set in the i-th client, yᵥ^{ji} is the ground truth of node v in the i-th client.

TABLE I
MAIN NOTATIONS USED IN THIS PAPER

| Notation | Description | Notation | Description |
|---|---|---|---|
| Sⱼ, Cᵢ^{j} | The j-th edge server and i-th client covered by Sⱼ | N, M | Total number of edge servers and clients |
| [symbol] , X, Y | Global graph, feature matrix, and label matrix | [symbol] ^{ji}, X^{ji}, Y^{ji} | Subgraph, sub-feature matrix, and sub-label matrix |
| Fᵢ^{j}, W_{(j, i)} | Local node classifier and the parameters | Fⱼ | Global node classifier |
| Pᵢ^{j} | Local graphic patcher | [symbol] _{F}_{ᵢ}^{j}, H^{(j, i)} | Loss function and the output of Fᵢ^{j} |
| H^{j} | Globally-shared information | Ā^{j}, X̅^{j} | Global topology graph and global potential features |
| [symbol] _{AS} | Loss function of assessor | [symbol] _{AE} | Loss function of autoencoder |

### B. FedGL. Centralized Federated Graph Learning

Since clients cannot directly capture cross-subgraph links that contain important neighbor information, the feature propagation from higher-order neighbors becomes inadequate, resulting in degraded classification performance. Therefore, it is crucial to explore the potential topology links among clients. To achieve this goal, we propose an improved centralized FGL framework, named FedGL. In FedGL, we consider an edge server to communicate with M clients. The FedGL leverages the edge server Sⱼ as an intermediary to facilitate the information flow among clients, where Sⱼ covers all clients, denoted by Mⱼ=M. Specifically, we incorporate a graph imputation generator to construct learnable links, thereby generating the latent links between subgraphs. To enhance feature propagation in local tasks and facilitate subsequent inference with the global model, we employ a L-layer GNN model with the local node classifier Fᵢ^{j}, defined as

$${H}^{( j , i )} = {GNNconv}_{w ( j , i )} ( {ε}^{ji} , {X}^{ji} ) \qquad ( 6 )$$

where GNNconv(⋅) is a GNN model and H^{(j,i)} indicates the GNN output of the l-th client covered by Sⱼ. The feature propagation of the (l+1)-th layer is given in Eq. (3). Moreover, the Cross-Entropy loss function is adopted for the l-th client covered by Sⱼ in the downstream tasks, defined as

$${ℒ}_{{F}_{i}^{j}} = {i}_{j}^{} ( {F}_{i}^{j} ( {W}_{( j , i )} ) ) = - {\sum }_{u = 1}^{\vert {t}_{ji}^{} \vert} {\sum }_{r = 1}^{C} {Y}_{ur}^{ji} ln {H}^{( j , i )}$$

where Yᵤ^{ji} is the inference vector of the node u conducted by local training.

For every edge-client communication in FedGL, each client parallelly trains the local node classifier Fᵢ^{j} parameterized by W_{(j,i)} in local training rounds, formulated as

$${W}_{( j , t )}^{t + 1} = {W}_{( j , t )}^{t} - α ∇ {R}_{i} ( {F}_{i} ( {W}_{( j , t )}^{t} ) ) \qquad ( 8 )$$

where α is the learning rate. t∈[Tₗ−1] indicates the local training rounds.

After local training, Sⱼ aggregates local parameters {W_{(j,i)}|i∈[Mⱼ]} to update global ones Wⱼ, and then broadcasts Wⱼ to all clients at each edge-client communication.

C. Graph Imputation Generator with Versatile Assessor

To capture the potential cross-subgraph links, we design a graph imputation generator and incorporate it with a versatile assessor to explore a learnable potential graph [symbol] ^{j}=( [symbol] ^{j}, ε̅^{j}, X̅^{j}) for mending the cross-subgraph links.

Graph Imputation Generator. To construct the globally shared information without revealing raw data, the clients upload the processed embeddings {H^{(j,i)}|i∈[Mⱼ]} to the edge server at every [symbol] intervals of edge-client communication, where the original linked nodes remain proximate in the low-dimensional space. Next, the graph imputation generator performs the fusion on the processed embeddings to obtain the globally-shared information H^{j}∈ [symbol] | [symbol] ^{j}|×c, where [symbol] ^{j} is the number of all clients covered by Sⱼ. Based on this, H^{j} is denoted as

$${H}^{j} = ⌊ {H}^{( j , 1 )} ‖ … ‖ {H}^{( j , {M}_{j} )} ⌋ \qquad ( 9 )$$

In real-world application scenarios of FGL, it is possible for each node in clients to own potential cross-subgraph links, and it may be insufficient for clients to propagate features in multi-hop neighbors if missing these cross-subgraph links. In response to this problem, the graph imputation generator utilizes the distance to evaluate the node similarity and construct the global topology graph, referred to Ā^{j}=H^{j}H^{j}^{^{T}}. Next, k most similar nodes are selected from this topology graph as potential cross-subgraph links, denoted by the set ε̅^{j}. To generate the potential feature vectors X̅^{j} under the guidance of the globally-shared information, an autoencoder parameterized by ΦAE is used to explore overcomplete underlying representations from H^{j}. Furthermore, to guarantee data privacy, the random noisy vector S is input to the autoencoder, and thus the output of the autoencoder is reconstructed as H̅^{j}=h(f(S)), where f(⋅) and h(⋅) are the encoder and decoder, respectively. It is noted that X̅^{j}=f(S) indicates the potential features expected to be extracted by the encoder. With the autoencoder, the random noisy vector is mapped to the same dimension as H^{j}, and the output of the (l+1)-th layer is defined as

$${\overline{H}}^{( j , l + 1 )} = σ ( {\overline{H}}^{( j , l )} {W}_{a}^{( j , l + 1 )} + {b}_{a}^{( j , l + 1 )} ) \qquad ( 10 )$$

Where Wₐ^{(j,l+1)}∈ [symbol] ^{d}^{ₗ}^{×d}^{ₗ₊₁} and bₐ^{(j,l+1)}∈ [symbol] ^{d}^{ₗ} are the layer-specific weights and biases, respectively. σ(⋅) denotes the activation function.

Versatile Assessor. Since the conditional distribution of H̅^{j} relies on X̅^{j} and is independent of S, {S→X̅^{j}→H̅^{j}} in the autoencoder follows the Markov principle. Therefore, we design a versatile assessor parameterized by ΦAS to supervise the quality of reconstruction data from the decoder, aiming to extract the expected underlying features X̅^{j} tailored for node classification. Considering the diversity of datasets, the assessor should be trainable to fit in specific tasks. Thus, the assessor adopts a fully-connected neural network to evaluate H̅^{j}. Concretely, the assessor takes the reconstructed globally shared information H̅^{j} as input in the form of a value, which is positively correlated with the quality evaluation of the reconstructed data. Hence, the autoencoder tends to obtain a higher value under the supervision of the assessor and extract more valid global information. Specifically, the loss function of the autoencoder is defined as

$${\hat{ℒ}}_{AE} = - {\sum }_{u} {𝔼}_{p ( {\overline{h}}_{u}^{j} \vert ∀ u ∈ {j}^{} )} ( Assor ( {\overline{h}}_{u}^{j} ) ) , = \frac{1}{\vert {j}^{} \vert} {\sum }_{u} log ( 1 - Assor ( {\overline{h}}_{u}^{j} ) ) , \qquad ( 11 )$$

where [symbol] ₚ(⋅) is the expectation of the variables in p(⋅), and p(h̅ᵤ^{j}|∀u∈v^{j}) indicates h̅ᵤ^{j} sampled from the distribution of H̅^{j}; Assor(⋅) is the assessor that evaluates the constructed global information. To distinguish the original and reconstructed global data, we regard the globally-shared information as the criterion and train the assessor to assign higher scores. In contrast, the assessor is trained to assign lower scores with the reconstructed global information. Therefore, the assessor is able to guide the autoencoder to evolve more discriminative representations of latent features. Specifically, the loss function of the assessor is defined as

$${\hat{ℒ}}_{AS} = \text{} - {\sum }_{u} [ \text{} {𝔼}_{p ( {h}_{u}^{j} \vert ∀ u ∈ {j}^{} )} ( Assor ( {h}_{u}^{j} ) ) + {𝔼}_{p ( {\overline{h}}_{u}^{j} \vert ∀ u ∈ {j}^{} )} ( 1 - Assor ( {\overline{h}}_{u}^{j} ) ) ] = \frac{1}{\vert {j}^{} \vert} {\sum }_{u} [ log ( 1 - Assor ( {h}_{u}^{j} ) ) + log ( Assor ( {\overline{h}}_{u}^{j} ) ) ] \qquad ( 12 )$$

where p(hᵤ^{j}|∀u∈v^{j}) denotes hᵤ^{j} sampled from the distribution of H^{j}.

The training processes of the autoencoder and assessor are performed simultaneously, where the assessor guides the autoencoder to learn more discriminative reconstructed data and potential features through back-propagation.

### D. Negative Sampling and Graph Fixing

Negative Sampling. To extract more refined potential features, we develop a negative sampling mechanism to concentrate on the pertinent information for node classification. Based on the proposed versatile assessor, we first set a threshold θ∈(0, 1) in every training iteration of the autoencoder and select the attributes in hᵤ^{j} that are less than θ. These attributes are deemed as negative and their feedbacks from the assessor are 0. Next, the zero-regularization is used to process these negatives, and thus both the autoencoder and the assessor can spotlight the representations that are meaningful for downstream tasks. Hence, the loss function of the assessor is updated and redefined as

$${ℒ}_{AS} = \frac{1}{\vert {j}^{} \vert} {\sum }_{u} [ log ( 1 - Assor ( {h}_{u}^{{j}_{}} ⊙ {e}_{u} ) ) + log ( Assor ( {\overline{h}}_{u}^{j} ⊙ {e}_{u} ) ) ] , \qquad ( 13 )$$

Where eᵤ is a c-dimensional vector that judges whether hᵤᵢ^{j}∈hᵤ^{j} is higher than θ (eᵤᵢ=1) or not (eᵤᵢ, =0). ⊙ is the element-wise multiplication.
i. Correspondingly, the loss function of the autoencoder is updated and redefined as

$${ℒ}_{A E} = \frac{1}{\vert {j}^{} \vert} {\sum }_{u} [ log ( 1 - Assor ( {\overline{h}}_{u}^{j} ⊙ {e}_{u} ) ) + {‖ {h}_{u}^{j} ⊙ ( - {e}_{u} ) - {\overline{h}}_{u}^{j} ( - {e}_{u} ) ‖}_{2}^{2} ] , \qquad ( 14 )$$

Where hᵤ^{j} and h̅ᵤ^{j} are the u-th vector of H^{j} and H̅^{j}, respectively. [symbol] is an indicator vector with the values of 1.

Through the above operations, ε̅^{j} and X̅^{j} are used to form the learnable potential graph [symbol] ^{j}=( [symbol] ^{j}, ε̅^{j}, X̅^{j}).

Graph Fixing. The edge server Sⱼ divides [symbol] ^{j} into some subgraphs, denoted by the set { [symbol] ^{ji}( [symbol] ^{ji}, ε̅^{ji}, [symbol] ^{ji})|i∈[Mⱼ]}, where ε̅^{ji}={ε̅ᵤᵥ^{ji}|ε̅ᵤᵥ^{ji}∈ε̅^{j}, ∀u, u∈v^{ji}} is the neighbor set of [symbol] ^{ji}, [symbol] ^{ji}={x̅ᵤ^{ji}|u∈v^{ji}}, and x̅ᵤ^{ji}={x̅ᵤ^{ji}|ēᵤᵥ^{ji}∈ε̅^{ji}} indicates the potential neighbor feature vectors of u. Next, Sⱼ assigns the subgraphs to each client. It is noted that each local client repairs the subgraph by using the local graphic patcher Pᵢ^{j} referring to [symbol] ^{ji}=Pᵢ^{j}( [symbol] ^{ji}). This process simulates the missing links, thereby promoting the feature propagation of local tasks in Eq. (3). By collaborating with the edge server, clients are expected to acquire diverse neighbor features from globally-shared information, thereby fixing cross-subgraph missing links. Moreover, these cross subgraph links contribute to training a global node classifier Fⱼ, aligning with the overall optimization objective in Eq. (4).

### E. SpreadFGL: Distributed Federated Graph Learning

In real-world application scenarios, a single edge server may encounter the problem of excessive costs and degraded performance as the number of clients expands, particularly when clients are geographically dispersed. To address this problem, we propose a novel distributed FGL framework, named SpreadFGL, that extends the FedGL to a multi-edge environment. The SpreadFGL is able to facilitate more efficient FGL training and better load balancing in a multiedge collaborative environment. We consider that there are N edge servers, and an edge server Sⱼ is equipped with a global node classifier Fⱼ parameterized by Wⱼ. Besides, a client only communicates with its closest edge server. There exist neighbor relationships among the servers, denoted by the matrix A∈ [symbol] ^{N×N}. If Sⱼ and Sⱼ are neighbors, aᵢⱼ=1; otherwise, aᵢⱼ=0. Moreover, the parameter transmission is permitted between neighbor servers.

In SpreadFGL, the clients adopt the L-layer GNNs and conduct the feature propagation via Eq. (3) during the local training. The edge servers exchange information with the covered clients in each edge-client communication. At each K intervals of edge-client communications, the clients and their nearest edge servers collaboratively utilize the shared information to extract the potential links based on the proposed graph imputation generator and negative sampling mechanism.

However, the potential cross-subgraph links strictly depend on the information provided by all clients. This not only violates the core idea of the SpreadFGL but also is impractical if the information is transmitted from the clients that are under the coverage of other servers. In light of these concerns, we design a weight regularizer during the local training. Based on trace normalization, the regularizer is used to enhance the network learning capability of the local node classifiers. Specifically, the loss function of the i-th client under the coverage of Sⱼ is defined as

$${ℒ}_{{F}_{i}^{j}} = {i}_{j}^{} ( {F}_{i}^{j} ( {W}_{( j , i )} ) ) = - {{\sum }_{u = 1}}^{\vert {t}_{ji}^{} \vert} {{\sum }^{c}}_{r = 1} {Y}_{ur}^{ji} ln {H}^{( j , i )} + Tr ( {W}_{( j , i , L )} {W}_{( j , i , L )}^{T} ) , \qquad ( 15 )$$

where Tr(⋅) is the square matrix trace. W_{(j,i,L)} indicates the parameters of L-th GNN layer for the local node classifier Fᵢ^{j}.

To better explore the potential cross-subgraph links by using the information from other servers, we adopt the topology structure at the edge layer to facilitate the parameter transmission between neighbor servers. This enables the information flow among clients via the gradient propagation at each [symbol] intervals of edge-client communication. Specifically, Sⱼ first aggregates the model parameters of its neighbor servers. Next, Sⱼ averages the parameters and broadcast them to the covered clients. This process can be described as

$${W}_{j} ← 1 / ( {\sum }_{r = 1}^{N} {a}_{rj} {M}_{r} ) {\sum }_{r = 1}^{N} {\sum }_{i = 1}^{{M}_{r}} {a}_{rj} {W}_{( r , i )} \qquad ( 16 )$$

The procedure of the proposed SpreadFGL is elaborated in Algorithm 1, whose core components have been described in detail before.

### 3. Performance Evaluation

we conduct ablation experiments to further verify the superiority of the core components designed in the proposed frameworks.

### A. Experiment Setup

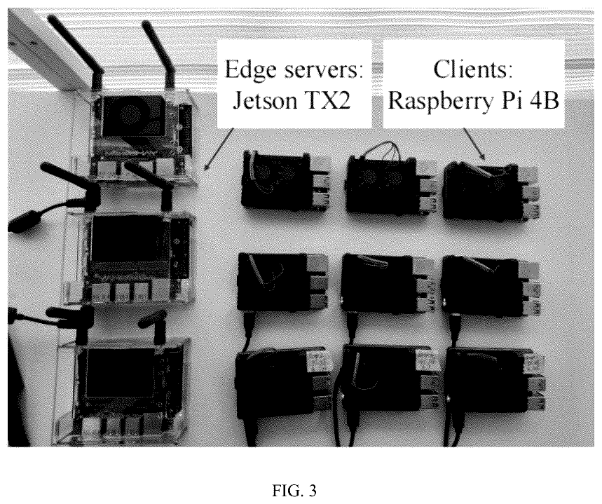

Real-world Testbed. As shown in FIG. 3, we build a hardware testbed to evaluate the proposed FedGL and SpreadFGL in real-world scenarios of edge-client collaboration. In the testbed, each Raspberry Pi 4B acts as a client that is equipped with Broadcom BCM2711 SoC @1.5 GHz with 4 GB RAM, and the OS is Raspbian GNU/Linux 11. Each Jetson TX2 acts as an edge server that is equipped with one 256-core NVIDIA Pascal® GPU, one Dual-core Denver 2 64-bit CPU and a quad-core Arm® Cortex®-A57 MPCore processor equipped with 8 GB RAM, and the OS is Ubuntu 18.04.6 LTS. The above hardware communicates through a 5 GHz WiFi network, and the proposed frameworks are implemented based on PyTorch. After completing local training, the client (Raspberry Pi 4B) uploads the local model parameters to its connected edge server (Jetson TX2). An edge server conducts aggregation and distributes the globally-shared model to its connected clients.

Datasets. The following four benchmark graph datasets are used in our experiments, as shown in Table II, where c is the number of classes, and |V̅ᵢ| and |ε̅ᵢ| are the average number of nodes and edges in subgraphs, and |Δε| is the number of missing cross-subgraph links.
Cora is a dataset of citation network, respectively. According to the application topics, the nodes are labeled with 7 classes.
Citeseer is a research application citation dataset, where nodes and edges indicate publications and citation re lationships, respectively. The citation relationships are defined as a word vector, and the nodes are classified into 6 classes.
WikiCS is a dataset derived from Wikipedia, where nodes and edges indicate computer science (CS) articles and different branches, respectively. All nodes are labeled with 6 classes.
CoauthorCS is an academic network dataset on microsoft scholar graph, where nodes and edges indicate authors and co-author relationships, respectively. The nodes are labeled with 15 classes based on research fields.

TABLE II
DESCRIPTION OF BENCHMARK GRAPH DATASETS

| Datasets | [symbol] | | | | [symbol] | | | | [symbol] | | | | [symbol] | | | |
|---|---|---|---|---|---|---|---|---|---|---|---|---|---|---|---|---|
| [symbol] | 7 | | | | 6 | | | | 10 | | | | 15 | | | |
| [symbol] | [symbol] | | | | [symbol] | | | | [symbol] | | | | [symbol] | | | |
| [symbol] | [symbol] | | | | [symbol] | | | | [symbol] | | | | [symbol] | | | |
| d | 1433 | | | | [symbol] | | | | 300 | | | | [symbol] | | | |
| M | 6 | 9 | 12 | 15 | 6 | 9 | 12 | 15 | 6 | 9 | 12 | 15 | 6 | 9 | 12 | 15 |
| [symbol] | [symbol] | 300 | 225 | [symbol] | [symbol] | [symbol] | 277 | 221 | [symbol] | [symbol] | [symbol] | [symbol] | [symbol] | [symbol] | [symbol] | [symbol] |
| [symbol] | [symbol] | [symbol] | 304 | [symbol] | [symbol] | 357 | 341 | 263 | [symbol] | [symbol] | [symbol] | [symbol] | [symbol] | [symbol] | [symbol] | [symbol] |
| [symbol] | [symbol] | [symbol] | [symbol] | [symbol] | 110 | 434 | 632 | 782 | [symbol] | [symbol] | [symbol] | [symbol] | [symbol] | [symbol] | [symbol] | [symbol] |

[symbol]

indicates data missing or illegible when filed

Comparison Algorithms. We compare our proposed FedGL and SpreadFGL with the following state-of-the-art algorithms.
LocalFGL is a local node classifier in the SpreadFGL, which is trained by a client independently.
FedAvg-fusion is an improved FedAvg framework, which trains a globally-shared GNN model with FedAvg via collaborating subgraphs distributed among clients.
FedSage+ adopts a linear predictor to locally repair the potential links between subgraphs, referring to the

latent information in each training round. It is worth noting that there are few studies for handling the FGL scenario with completely missing cross-subgraph links between clients. FedSage+ is deemed as the state-of-the-art algorithm for studying the missing cross-subgraph links in FGL fields. However, it still suffers from performance bottlenecks and has not been well solved in real-world scenarios.

Parameter Settings. For the proposed SpreadFGL and FedGL, we adopt the GraphSAGE with two layers and use the GCN aggregator as local node classifiers. The autoencoder employs 4 fully-connected layers, where the neural number of encoder and decoder are {c, 16, d} and {d, 16, c}, respectively. In the autoencoder, the Softmax is used as an activation function in the last layer. The assessor adopts a fully connected neural network, where the hidden neural number is {c, 128, 16, 1}. In the assessor, the Sigmoid is used as an activation function in the last layer while the ReLU is used in the rest layers. The training iterations of the autoencoder and assessor are Tₐₑ Tₐₛ=5 and Tₐₛ=3, respectively, and the Adam optimizer is used to update parameters with the learning rate of 0.001. The threshold θ is set to 1/c and k ranges in [3, 20]. Moreover, we select [20%, 60%] samples as the training set and randomly choose 20% as the testing set. The Louvain algorithm is used to measure the subgraph similarity for clients. The FedGL uses an edge server and the SpreadFGL adopts three edge servers for collaborative training with a ring topology structure, where the number of clients ranges in [6, 15]. The Adam optimizer is used to update the parameters of local classifiers with the learning rate lr=0.01. Besides, we use the well-known accuracy (ACC) and macro F1-score (F1) as performance metrics.

### B. Experiment Results and Analysis

Node Classification Accuracy. As shown in Table III, the proposed SpreadFGL and FedGL can both achieve higher classification accuracy than other state-of-the-art algorithms under different datasets, indicating the superiority of the proposed frameworks for node classification tasks. Specifically, the significant performance gap between the LocalFGL and SpreadFGL verifies the advantages of using the proposed edge client collaboration mechanism. The FedGL and SpreadFGL outperform the FedSage+ by around 12.78% and 14.71% in terms of ACC and F1, respectively. This demonstrates that the FedGL and SpreadFGL gain more generalized potential cross subgraph links through the global information flow, further validating the effectiveness of the proposed graph imputation generator. Moreover, compared to the FedGL, the SpreadFGL achieves better performance on most of the datasets under various scenarios with different numbers of clients. This indicates that the information flow between clients and edge servers utilized in the SpreadFGL effectively promotes the repair of missing links among clients even though the scenario becomes complex with more clients.

TABLE III
NODE CLASSIFICATION ACCURACY (%) ON FOUR DATASETS WITH LABELED
RATIO OF [symbol] AND M = 6, 9, 12, 15

| Dataset | | [symbol] | | | | [symbol] | | | |
|---|---|---|---|---|---|---|---|---|---|
| Methods | Metrics | M = 6 | M = 9 | M = 12 | M = 15 | M = 6 | M = 9 | M = 12 | M = 15 |
| LocalFGL | ACC | 62.20 | 60.00 | 57.14 | 63.33 | 51.63 | [symbol] | [symbol] | 43.75 |
| | [symbol] | 56.71 | 52.43 | 53.96 | 41.47 | 47.85 | 49.70 | 46.00 | 37.90 |
| FedAvg-fusion | ACC | 81.70 | 76.89 | [symbol] | 70.63 | 71.57 | 71.42 | [symbol] | 68.64 |
| | [symbol] | 79.15 | 74.05 | [symbol] | 63.83 | 61.89 | 67.17 | 60.00 | 60.11 |
| FedSage+ | ACC | 80.26 | 80.18 | [symbol] | [symbol] | [symbol] | 72.87 | 72.46 | 72.09 |
| | [symbol] | 79.98 | 79.63 | 78.72 | [symbol] | [symbol] | 62.25 | 61.65 | 60.45 |
| [symbol] | ACC | 84.47 | 83.36 | 82.81 | [symbol] | [symbol] | 73.08 | 73.53 | 73.03 |
| | [symbol] | 84.08 | 83.11 | 81.63 | 75.34 | [symbol] | 67.53 | 64.39 | 63.72 |
| SpreadFGL | ACC | [symbol] | [symbol] | 82.59 | [symbol] | [symbol] | 73.43 | 73.72 | [symbol] |
| | [symbol] | 84.32 | 83.31 | 82.34 | [symbol] | 67.72 | 68.12 | [symbol] | [symbol] |
| Dataset | | [symbol] | | | | CoauthorCS | | | |
| Methods | Metrics | M = 6 | M = 9 | M = 12 | M = 15 | M = 6 | M = 9 | M = 12 | M = 15 |
| LocalFGL | ACC | [symbol] | 55.56 | [symbol] | 47.46 | [symbol] | 80.00 | [symbol] | 79.90 |
| | [symbol] | 52.06 | 48.50 | [symbol] | 42.31 | 57.45 | [symbol] | [symbol] | [symbol] |
| FedAvg-fusion | ACC | 76.25 | 74.70 | 73.67 | 73.37 | 87.73 | 86.96 | 87.35 | [symbol] |
| | [symbol] | 68.98 | 66.52 | 63.00 | 62.53 | 73.46 | 67.15 | 62.68 | [symbol] |
| FedSage+ | ACC | 36.32 | 38.73 | 36.94 | [symbol] | [symbol] | [symbol] | 87.68 | 88.03 |
| | [symbol] | [symbol] | [symbol] | [symbol] | [symbol] | 66.57 | 67.06 | 61.85 | [symbol] |
| [symbol] | ACC | 77.56 | 76.97 | 76.24 | 75.26 | [symbol] | 89.74 | 87.72 | 88.62 |
| | [symbol] | 70.71 | [symbol] | [symbol] | 64.37 | [symbol] | [symbol] | 65.22 | 65.06 |
| SpreadFGL | ACC | [symbol] | [symbol] | 77.10 | 76.32 | [symbol] | [symbol] | [symbol] | [symbol] |
| | [symbol] | [symbol] | 71.32 | [symbol] | 67.49 | 74.54 | 68.13 | [symbol] | [symbol] |

[symbol]

indicates data missing or illegible when filed

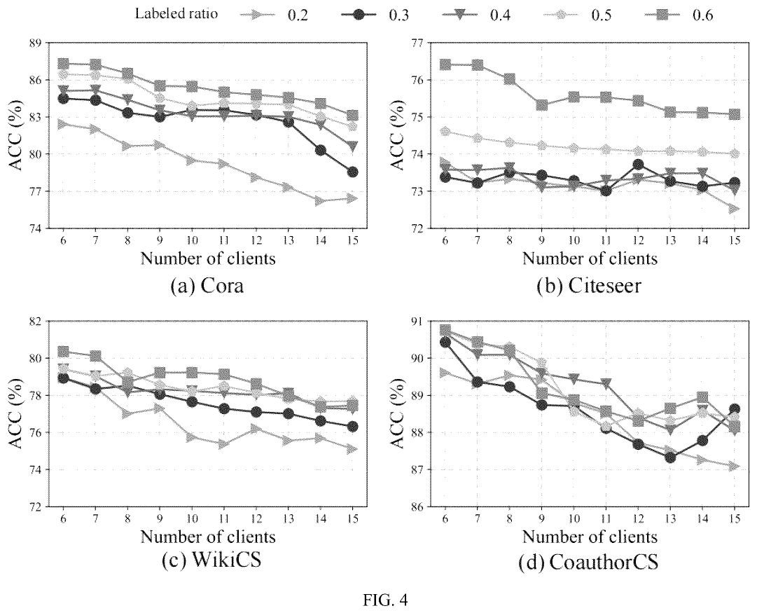

Performance with Different Labeled Ratios. FIG. 4 depicts the ACC of the SpreadFGL on different datasets with various labeled ratios, varying from 0.2 to 0.6. With the same labeled ratio, the ACC tends to decrease as the datasets are distributed on more clients. This is because massive heterogeneous clients cause difficulty and instability in the aggregation process of model parameters. Under this scenario, the performance of the classic FGL might be seriously degraded since it adopts a centralized training manner. It is noted that the ACC is rising as the labeled ratio increases, but with fewer data points presenting the opposite situation. This discrepancy may be attributed to the sparsity of certain classes in the feature space, leading to insufficient model training and thus affecting classification accuracy.

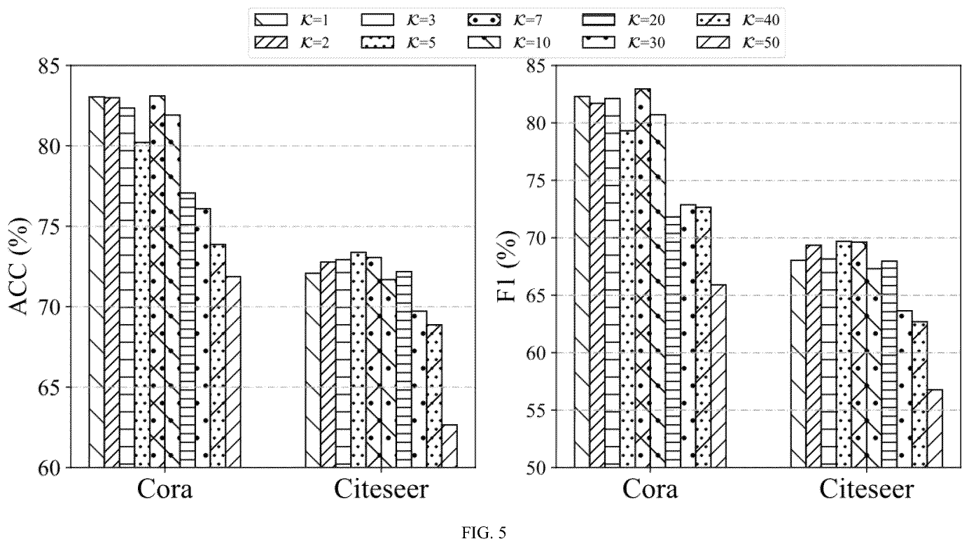

Parameter Sensitivity. We analyze the parameter sensitivity of the proposed SpreadFGL on different datasets with respect to the hyperparameter K and Tₗ. As shown in FIG. 5, K remarkably affects the classification accuracy in terms of the ACC and F1. Specifically, the ACC and F1 stay at a low level when K is more than 10, while they keep stable as K ranges in [1, 10], attributed to the reason that the graph imputation

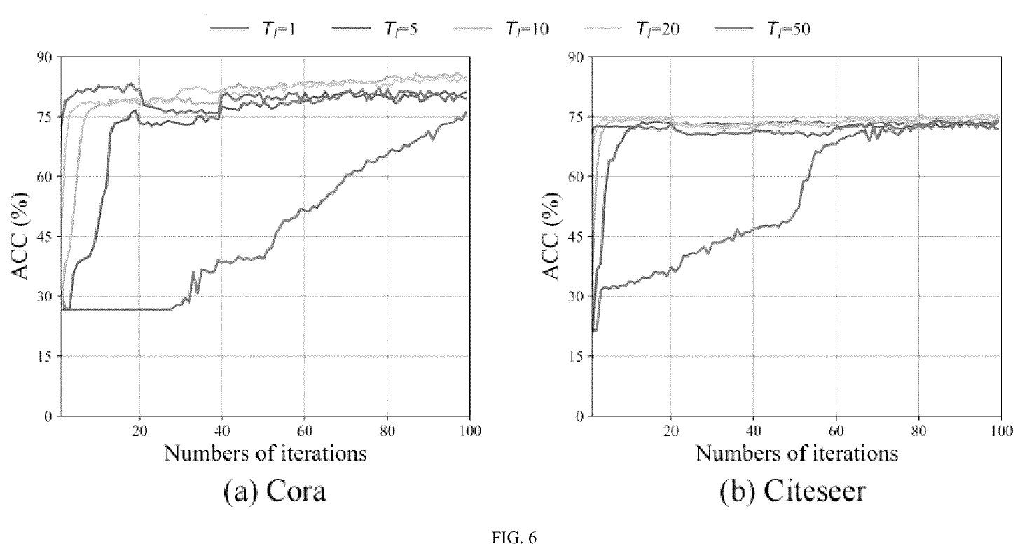

generator can better repair the missing links in subgraphs to promote feature propagation in local models within fewer edge-client communications, thereby improving the training of the global node classifiers. In this regard, the suggested values of K range from 1 to 10. FIG. 6 presents the influence of local training iteration Tₗ on the SpreadFGL. The SpreadFGL converges slowly and achieves a local optimum when Tₗ is less than 5. This is because local models cannot sufficiently learn feature patterns within fewer local iterations, leading to slow model convergence. It is noted that the ACC declines when Tₗ exceeds 50 due to the overfitting of the model. Therefore, a suitable range of Tₗ is [10, 20], considering both accuracy and convergence speed.

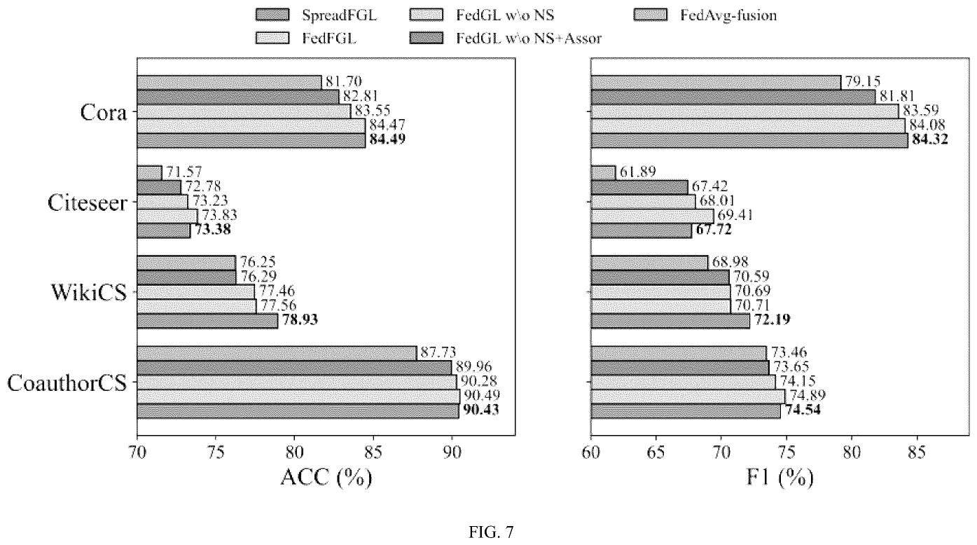

Ablation Study. As shown in FIG. 7, we regard the FedAvgfusion as a baseline that adopts the FedAvg to aggregate the parameters from multiple clients on an edge server. Also, we test the performance of the FedGL without a negative sampling mechanism (denoted by NS), versatile assessor (denoted by Assor), and the FedGL without NS. The proposed FedGL and SpreadFGL achieve comparable performance and outperform others by combining graph imputation generator, versatile assessor, and negative sampling mechanism. It is noted that there is only a small performance improvement when just utilizing one of the core components designed in the proposed frameworks. It obtains considerable improvement when the SpreadFGL adopts all the proposed components. This demonstrates that the integration of these components is able to better extract more refined potential cross-subgraph links, thereby promoting the accuracy of classification tasks.

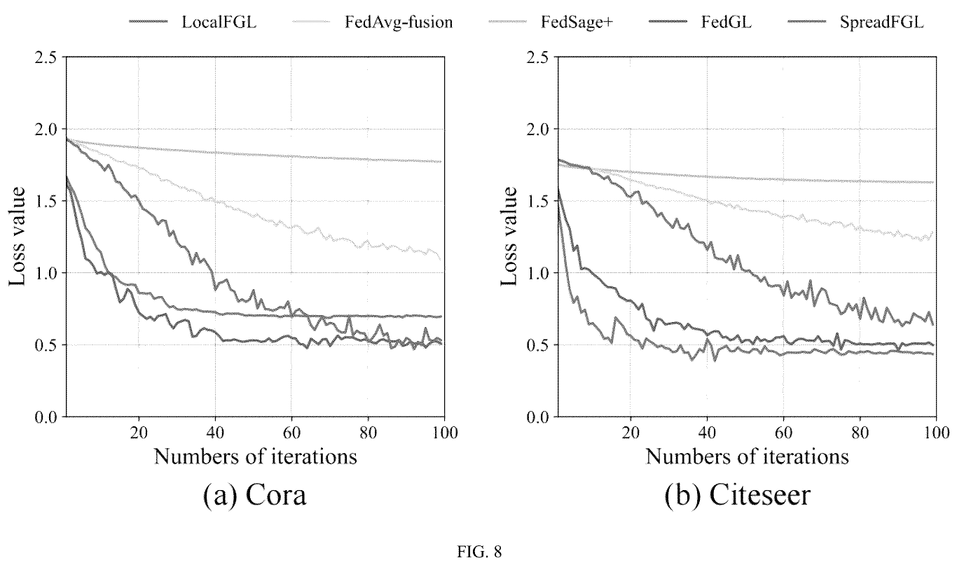

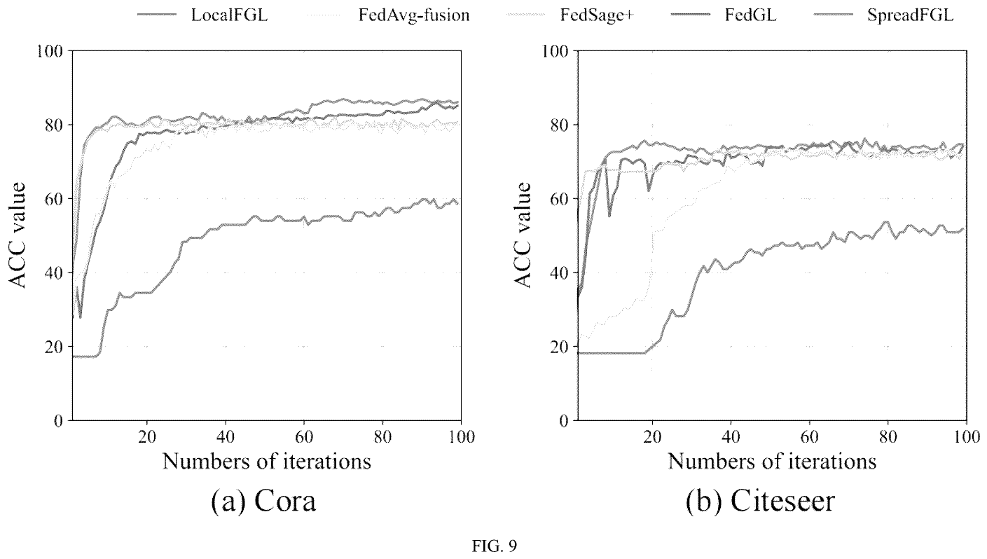

Convergence Validation. FIG. 8 illustrates the training loss of different FGL-based frameworks on Cora and Citeseer datasets. It can be observed that both the FedGL and SpreadFGL can always rapidly converge compared to the state-of the-art algorithms, validating the effectiveness of the proposed frameworks in node classification tasks. FIG. 9 shows the

In this application, we propose a novel FGL-based framework named FedGL and its extended framework SpreadFGL, addressing the challenges of generating cross-subgraph links and single-node overloading. First, we design the FedGL to repair the missing links between clients, where a new graph imputation generator is developed that incorporates a versatile assessor and negative sampling mechanism to explore refined global information flow, extracting unbiased latent links and thus improving the training effect. Next, to alleviate the overloading issue at the edge layer, we extend the FedGL and propose the SpreadFGL with multi-edge collaboration to enhance the global information exchange. Extensive experiments are conducted on real-world testbed and benchmark graph datasets to verify the superiority of the proposed FedGL and SpreadFGL. The results show that the FedGL and SpreadFGL outperform state-of-the-art algorithms in terms of model accuracy. Further, through ablation experiments and convergence analysis, we validate the effectiveness of the core components designed in the proposed frameworks and the advantage of the SpreadFGL for achieving faster convergence speed.

What is claimed is:

1. An Edge-Client Collaborative Federated Graph Learning with Adaptive Neighbor Generation, comprising: consider a typical FGL scenario with distributed graph datasets; based on this setting, first propose an improved centralized FGL framework, named FedGL; next, extend the FedGL to a scenario of multi-edge collaboration and propose a novel distributed FGL framework, named SpreadFGL.

2. The Edge-Client Collaborative Federated Graph Learning with Adaptive Neighbor Generation according to claim 1, wherein consider an edge server to communicate with M clients; the FedGL leverages the edge server Sⱼ as an intermediary to facilitate the information flow among clients, where Sⱼ covers all clients, denoted by Mⱼ=M; incorporate a graph imputation generator to construct learnable links, thereby generating the latent links between subgraphs; employ a L-layer GNN model with the local node classifier Fᵢ^{j}, defined as
$${H}^{( j , i )} = {GNNconv}_{w ( j , i )} ( {ε}^{ji} , {X}^{ji} ) \qquad ( 6 )$$
where GNNconv (⋅) is a GNN model and H^{(j,i)} indicates the GNN output of the l-th client covered by Sⱼ; the feature propagation of the (l+1)-th layer is given in Eq. (3); moreover, the Cross-Entropy loss function is adopted for the l-th client covered by Sⱼ in the downstream tasks, defined as
$${ℒ}_{{F}_{i}^{j}} = {i}_{j}^{} ( {F}_{i}^{j} ( {W}_{( j , i )} ) ) = - {{\sum }_{u = 1}}^{\vert {t}_{ji}^{} \vert} {{\sum }_{r = 1}}^{c} {Y}_{ur}^{ji} ln {H}^{( j , i )} \qquad ( 7 )$$
where Yᵤ^{ji} is the inference vector of the node u conducted by local training;
for every edge-client communication in FedGL, each client parallelly trains the local node classifier Fᵢ^{j} parameterized by W_{(j,i)} in local training rounds, formulated as
$${W}_{( j , t )}^{t + 1} = {W}_{( j , t )}^{t} - α ∇ {R}_{i} ( {F}_{i} ( {W}_{( j , t )}^{t} ) ) \qquad ( 8 )$$
where α is the learning rate; t∈[Tₗ−1] indicates the local training rounds;
after local training, Sⱼ aggregates local parameters {W_{(j,i)}|i∈[Mⱼ]} to update global ones Wⱼ, and then broadcasts Wⱼ to all clients at each edge-client communication.

3. The Edge-Client Collaborative Federated Graph Learning with Adaptive Neighbor Generation according to claim 1, wherein the clients upload the processed embeddings {H^{(j,i)}|i∈[Mⱼ]} to the edge server at every [symbol] intervals of edge-client communication, where the original linked nodes remain proximate in the low-dimensional space; next, the graph imputation generator performs the fusion on the processed embeddings to obtain the globally-shared information H^{j}∈ [symbol] | [symbol] ^{j}|×c where [symbol] ^{j} is the number of all clients covered by Sⱼ; based on this, H^{j} is denoted as
$${H}^{j} = ⌊ {H}^{( j , 1 )} ‖ ⋯ ‖ {H}^{( j , {M}_{j} )} ⌋ . \qquad ( 9 )$$

4. The Edge-Client Collaborative Federated Graph Learning with Adaptive Neighbor Generation according to claim 1, wherein the graph imputation generator utilizes the distance to evaluate the node similarity and construct the global topology graph, referred to Ā^{j}=H^{j}H^{j}^{^{T}}; next, k most similar nodes are selected from this topology graph as potential cross-subgraph links, denoted by the set ε̅^{j}; to generate the potential feature vectors X̅^{j} under the guidance of the globally-shared information, an autoencoder parameterized by ΦAE is used to explore overcomplete underlying representations from H^{j}; furthermore, to guarantee data privacy, the random noisy vector S is input to the autoencoder, and thus the output of the autoencoder is reconstructed as H̅^{j}=h(f(S)), where f(⋅) and h(⋅) are the encoder and decoder, respectively; it is noted that X̅^{j}=f(S) indicates the potential features expected to be extracted by the encoder; with the autoencoder, the random noisy vector is mapped to the same dimension as H^{j}, and the output of the (l+1)-th layer is defined as
$${\overline{H}}^{( j , l + 1 )} = σ ( {\overline{H}}^{( j , l )} {W}_{a}^{( j , l + 1 )} + {b}_{a}^{( j , l + 1 )} ) \qquad ( 10 )$$
where Wₐ^{(j,l+1)}∈ [symbol] ^{d}^{ₗ}^{×d}^{ₗ₊₁} and bₐ^{(j,l+1)}∈ [symbol] ^{d}^{ₗ} are the layer-specific weights and biases, respectively; σ(⋅) denotes the activation function.

5. The Edge-Client Collaborative Federated Graph Learning with Adaptive Neighbor Generation according to claim 1, wherein the assessor adopts a fully-connected neural network to evaluate H̅^{j}; the assessor takes the reconstructed globally shared information H̅^{j} as input in the form of a value, which is positively correlated with the quality evaluation of the reconstructed data; hence, the autoencoder tends to obtain a higher value under the supervision of the assessor and extract more valid global information; specifically, the loss function of the autoencoder is defined as
$$\begin{matrix}{\hat{ℒ}}_{AE} = - {\sum }_{u} {𝔼}_{p ( {\overline{h}}_{u}^{j} \vert ∀ u ∈ {j}^{} )} ( Assor ( {\overline{h}}_{u}^{j} ) ) , \\ = \frac{1}{\vert {j}^{} \vert} {\sum }_{u} log ( 1 - Assor ( {\overline{h}}_{u}^{j} ) ) ,\end{matrix} \qquad ( 11 )$$
where [symbol] ₚ (⋅) is the expectation of the variables in p(⋅), and p(h̅ᵤ^{j}|∀u∈v^{j}) indicates h̅ᵤ^{j} sampled from the distribution of H̅^{j}; Assor(⋅) is the assessor that evaluates the constructed global information; to distinguish the original and reconstructed global data, we regard the globally-shared information as the criterion and train the assessor to assign higher scores; the assessor is trained to assign lower scores with the reconstructed global information; the assessor is able to guide the autoencoder to evolve more discriminative representations of latent features; the loss function of the assessor is defined as
$$\begin{matrix}{\hat{ℒ}}_{AS} = - {\sum }_{u} [ {𝔼}_{p ( {h}_{u}^{j} \vert ∀ u ∈ {j}^{} )} ( Assor ( {h}_{u}^{j} ) ) + \\ {𝔼}_{p ( {\overline{h}}_{u}^{j} \vert ∀ u ∈ {j}^{} )} ( 1 - Assor ( {\overline{h}}_{u}^{j} ) ) ] \\ = \frac{1}{\vert {j}^{} \vert} {\sum }_{u} [ log ( 1 - Assor ( {h}_{u}^{j} ) ) + log ( Assor ( {\overline{h}}_{u}^{j} ) ) ]\end{matrix} \qquad ( 12 )$$
where p(h̅ᵤ^{j}|∀u∈v^{j}) denotes hᵤ^{j} sampled from the distribution of H^{j};
the training processes of the autoencoder and assessor are performed simultaneously, where the assessor guides the autoencoder to learn more discriminative reconstructed data and potential features through back-propagation.

6. The Edge-Client Collaborative Federated Graph Learning with Adaptive Neighbor Generation according to claim 1, wherein based on the proposed versatile assessor, we first set a threshold θ∈(0, 1) in every training iteration of the autoencoder and select the attributes in hᵤ^{j} that are less than θ; these attributes are deemed as negative and their feedbacks from the assessor are 0; next, the zero-regularization is used to process these negatives, and thus both the autoencoder and the assessor can spotlight the representations that are meaningful for downstream tasks; hence, the loss function of the assessor is updated and redefined as
$${ℒ}_{AS} = \frac{1}{\vert {j}^{} \vert} {\sum }_{u} [ log ( 1 - Assor ( {h}_{u}^{j} ⊙ {e}_{u} ) ) + log ( Assor ( {\overline{h}}_{u}^{j} ⊙ {e}_{u} ) ) ] , \qquad ( 13 )$$
where eᵤ is a c-dimensional vector that judges whether hᵤᵢ^{j}∈hᵤ^{j} is higher than θ (eᵤᵢ=1) or not (eᵤᵢ=0); ⊙ is the element-wise multiplication; correspondingly, the loss function of the autoencoder is updated and redefined as
$${ℒ}_{AE} = \frac{1}{\vert {}^{j} \vert} {\sum }_{u} [ log ( 1 - Assor ( {\overline{h}}_{u}^{j} ⊙ {e}_{u} ) ) + {‖ {h}_{u}^{j} ⊙ ( - {e}_{u} ) - {\overline{h}}_{u}^{j} ⊙ ( - {e}_{u} ) ‖}_{2}^{2} ] , \qquad ( 14 )$$
where hᵤ^{j} and h̅ᵤ^{j} are the u-th vector of H^{j} and H̅^{j}, respectively; [symbol] is an indicator vector with the values of 1; through the above operations, ε̅^{j} and X̅^{j} are used to form the learnable potential graph [symbol] ^{j}=( [symbol] ^{j}, ε̅^{j}, X̅^{j}).

7. The Edge-Client Collaborative Federated Graph Learning with Adaptive Neighbor Generation according to claim 1, wherein the edge server Sⱼ divides [symbol] ^{j} into some subgraphs, denoted by the set { [symbol] ^{ji}( [symbol] ^{ji}, ε̅^{ji}, [symbol] ^{ji})|i∈[Mⱼ]}, where ε̅^{ji}={ε̅ᵤᵥ^{ji}|ε̅ᵤᵥ^{ji}∈ε̅^{j}, ∀u, u∈v^{ji}} is the neighbor set of [symbol] ^{ji}, [symbol] ^{ji}={x̅ᵤ^{ji}|u∈ [symbol] ^{ji}}, and x̅ᵤ^{ji}={x̅ᵤ^{ji}|ēᵤᵥ^{ji}∈ε̅^{ji}} indicates the potential neighbor feature vectors of u; next, Sⱼ assigns the subgraphs to each client; it is noted that each local client repairs the subgraph by using the local graphic patcher Pᵢ^{j} referring to [symbol] ^{ji}=Pᵢ^{j}( [symbol] ^{ji}); by collaborating with the edge server, clients are expected to acquire diverse neighbor features from globally-shared information, thereby fixing cross-subgraph missing links.

8. The Edge-Client Collaborative Federated Graph Learning with Adaptive Neighbor Generation according to claim 1, wherein propose a novel distributed FGL framework, named SpreadFGL, that extends the FedGL to a multi-edge environment; the SpreadFGL is able to facilitate more efficient FGL training and better load balancing in a multiedge collaborative environment; consider that there are N edge servers, and an edge server Sⱼ is equipped with a global node classifier Fⱼ parameterized by Wⱼ; besides, a client only communicates with its closest edge server; there exist neighbor relationships among the servers, denoted by the matrix A∈ [symbol] ^{N×N}; if Sⱼ and Sⱼ are neighbors, aᵢⱼ=1; otherwise, aᵢⱼ=0; moreover, the parameter transmission is permitted between neighbor servers;
in SpreadFGL, the clients adopt the L-layer GNNs; the edge servers exchange information with the covered clients in each edge-client communication; at each K intervals of edge-client communications, the clients and their nearest edge servers collaboratively utilize the shared information to extract the potential links based on the proposed graph imputation generator and negative sampling mechanism;
design a weight regularizer during the local training; based on trace normalization, the regularizer is used to enhance the network learning capability of the local node classifiers; specifically, the loss function of the i-th client under the coverage of Sⱼ is defined as
$$\begin{matrix}{ℒ}_{{F}_{i}^{j}} = {i}_{j}^{} ( {F}_{i}^{j} ( {W}_{( j , i )} ) ) \\ = - {{\sum }_{u = 1}}^{\vert {ji}^{} \vert} {{\sum }_{r = 1}}^{c} {Y}_{ur}^{ji} ln {H}^{( j , i )} + Tr ( {W}_{( j , i , L )} {W}_{( j , i , L )}^{T} ) ,\end{matrix} \qquad ( 15 )$$
where Tr(⋅) is the square matrix trace; W_{(j,i,L)} indicates the parameters of L-th GNN layer for the local node classifier Fᵢ^{j};
to better explore the potential cross-subgraph links by using the information from other servers, adopt the topology structure at the edge layer to facilitate the parameter transmission between neighbor servers; this enables the information flow among clients via the gradient propagation at each [symbol] intervals of edge-client communication; specifically, Sⱼ first aggregates the model parameters of its neighbor servers; next, Sⱼ averages the parameters and broadcast them to the covered clients; this process can be described as
$${W}_{j} ← 1 / ( {\sum }_{r = 1}^{N} {a}_{rj} {M}_{r} ) {\sum }_{r = 1}^{N} {\sum }_{i = 1}^{{M}_{r}} {a}_{rj} {W}_{( r , i )} \qquad ( 16 )$$
